(19) United States
(12) Patent Application Publication
(10) Pub. No.: US 2026/0211990 A2
(43) Pub. Date: Jul. 23, 2026

(54) METHODS AND SYSTEMS FOR USER IMAGE GENERATION

(71) Applicant: META PLATFORMS, INC., Menlo Park, CA (US)

(72) Inventors: Vincent Charles Cheung, Menlo Park, CA (US); John Hanlon, Brooklyn, NY (US); Animesh Sinha, San Francisco, CA (US); Aaron Thomas Nissenbaum, Seattle, WA (US)

(21) Appl. No.: 19/276,585

(22) Filed: Jul. 22, 2025

Related U.S. Application Data
(60) Provisional application No. 63/674,222, filed on Jul. 22, 2024.

(51) Int. Cl. G06F 21/32

(52) U.S. Cl. CPC G06F 21/32

(57) ABSTRACT

A method includes verifying an identity of a first user based on one or more first reference images of the user. The method also includes determining, based on a prompt provided to a computing system by the first user, a context and whether the prompt references the first user. The method further includes retrieving, from a first private memory store associated with the first user, the one or more first reference images based on the first user having granted permission to use the one or more first reference images. The method still further includes generating, using a generative AI model, a media item based on the context, the prompt, and the one or more first reference images. The method also includes displaying the generated media item via a user interface associated with the first user.

### CROSS-REFERENCE TO RELATED APPLICATIONS

This application claims priority to U.S. Provisional Application No. 63/674,222, filed Jul. 22, 2024, entitled, “METHODS AND SYSTEMS FOR USER IMAGE GENERATION,” the contents of which is incorporated by reference herein in its entirety.

### TECHNOLOGICAL FIELD

The present disclosure generally relates to methods, apparatuses, and computer program products for an intelligent media generation system to generate media.

### BACKGROUND

Electronic devices are constantly changing and evolving to provide the user with flexibility and adaptability. With increasing adaptability in electronic devices, users are taking and maintaining their devices on their person during various everyday activities. This may lead to many users wanting to express themselves. For example, users may attempt to express themselves via various methods, such as, but not limited to, capturing images, recording videos, or recording audio, and sharing those captured forms of media. However, there may be limitations to the self-expression of users depending on what may be captured in an environment associated with the user or what forms of media may be found on the Internet.

### BRIEF SUMMARY

Various systems, methods, and devices are described for utilizing artificial intelligence (AI) to create (e.g., generate) media comprising likeness of one or more users of a plurality of users based on an input.

In various aspects of the present disclosure, a method includes verifying an identity of a first user based on one or more first reference images of the user. The method also includes determining, based on a prompt provided to a computing system by the first user, a context and whether the prompt references the first user. The method further includes retrieving, from a first private memory store associated with the first user, the one or more first reference images based on the first user having granted permission to use the one or more first reference images. The method also includes generating, using a generative AI model, a media item based on the context, the prompt, and the one or more first reference images. The method further includes displaying the generated media item via a user interface associated with the first user.

In some other aspects of the present disclosure, a system includes one or more processors, and at least one memory communicatively coupled to the one or more processors and comprising computer-readable instructions that upon execution by the one or more processors cause the one or more processors to perform operations comprising verifying an identity of a first user based on one or more first reference images of the user. Execution of the computer-readable instructions also causes the one or more processors to perform operations comprising determining, based on a prompt provided to a computing system by the first user, a context and whether the prompt references the first user. Execution of the computer-readable instructions further causes the one or more processors to perform operations comprising retrieving, from a first private memory store associated with the first user, the one or more first reference images based on the first user having granted permission to use the one or more first reference images. Execution of the computer-readable instructions also causes the one or more processors to perform operations comprising generating, using a generative AI model, a media item based on the context, the prompt, and the one or more first reference images. Execution of the computer-readable instructions further causes the one or more processors to perform operations comprising displaying the generated media item via a user interface associated with the first user.

Some other aspects are directed to a non-transitory computer-readable medium comprising computer-executable instructions, which, when executed, cause verifying an identity of a first user based on one or more first reference images of the user. Execution of the computer-readable instructions also causes determining, based on a prompt provided to a computing system by the first user, a context and whether the prompt references the first user. Execution of the computer-readable instructions further causes retrieving, from a first private memory store associated with the first user, the one or more first reference images based on the first user having granted permission to use the one or more first reference images. Execution of the computer-readable instructions also causes generating, using a generative AI model, a media item based on the context, the prompt, and the one or more first reference images. Execution of the computer-readable instructions further causes displaying the generated media item via a user interface associated with the first user.

In various examples, systems and methods of AI creating (e.g., generating) media may include receiving an input associated with a user, via a user device; determining a context associated with the input; referencing a database to determine if the user has given consent to utilize data associated with the appearance of the user; capturing one or more images of the user to obtain data associated with the user's appearance; generating a media item based on the determined context and data associated with appearance of the user; and displaying the generated media item.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 is a block diagram of a system, in accordance with various aspects of the present disclosure.

FIG. 2 illustrates a block diagram of an exemplary hardware/software architecture of a communication device such as, for example, user equipment (UE) 30, in accordance with various aspects of the present disclosure.

FIG. 3 is a block diagram of an exemplary computing system 300, in accordance with various aspects of the present disclosure.

FIG. 4 is a diagram illustrating an example user interface flow 400 for generating AI images in a messaging context, in accordance with various aspects of the present disclosure.

FIG. 5 is a block diagram illustrating an example of a process 500 for generating AI images, in accordance with various aspects of the present disclosure.

FIGS. 6, 7, 8, 9, 10, and 11 are diagrams illustrating examples of graphical user interfaces, in accordance with various aspects of the present disclosure.

FIG. 12A and FIG. 12B illustrate examples of graphical user interfaces, in accordance with various aspects of the present disclosure.

FIG. 13 illustrates an example system architecture for generating a media item (e.g., a synthetic image), in accordance with various aspects of the present disclosure.

FIG. 14 illustrates a machine learning and training model, in accordance with various aspects of the present disclosure.

FIG. 15 is a flow diagram illustrating an example of a process performed by a generative AI platform, in accordance with some aspects of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

Electronic devices are constantly changing and evolving to provide the user with flexibility and adaptability. With increasing adaptability in electronic devices users are taking and maintaining their devices on their person during various everyday activities. This may lead to many users wanting to capture their environment to share with other others. In some instances, users capturing their environment may be a form of self-expression. Research has shown that the best self-expression online relies on great visuals. Visual expression, in many cases, is deeply contextual which may lead to users wanting more creative control over the assets (e.g., stickers, gifs, photos) users utilize to express themselves.

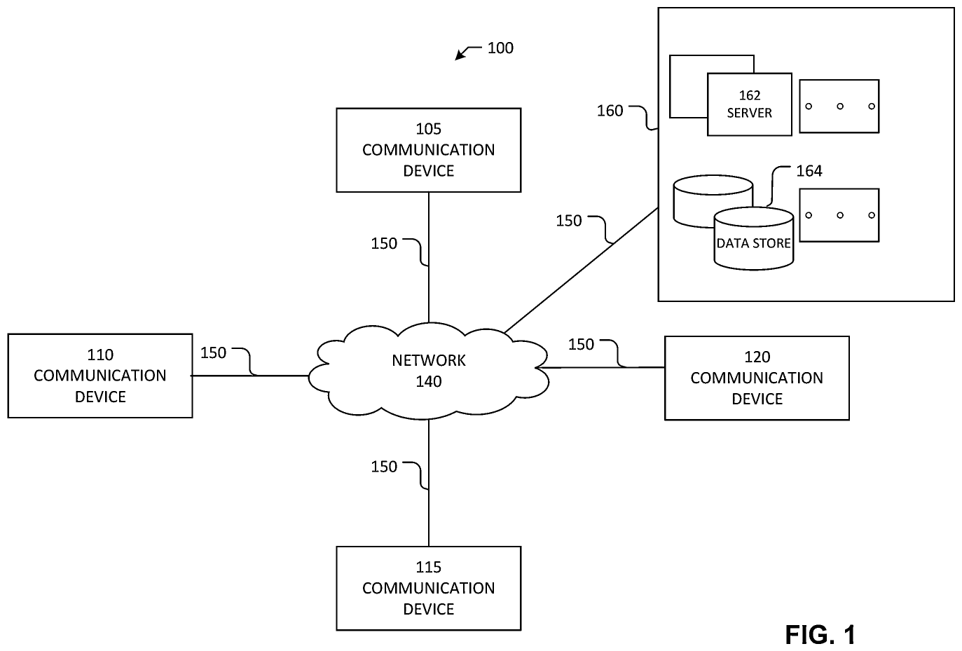

FIG. 1 is a block diagram of a system, in accordance with various aspects of the present disclosure. As shown in FIG. 1, the system 100 may include one or more communication devices 105, 110, 115 and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115, and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some examples, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

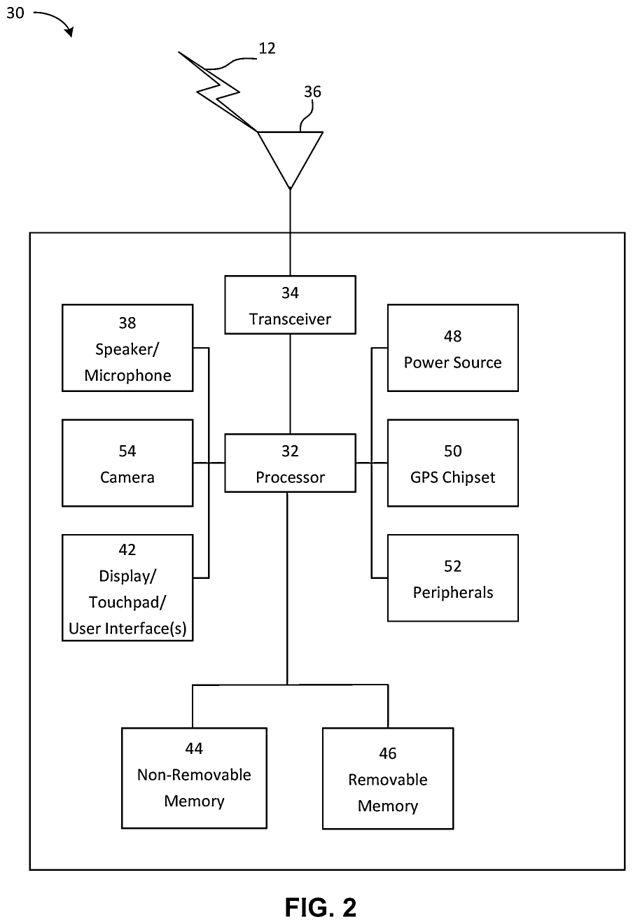

FIG. 2 illustrates a block diagram of an exemplary hardware/software architecture of a communication device such as, for example, user equipment (UE) 30, in accordance with various aspects of the present disclosure. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

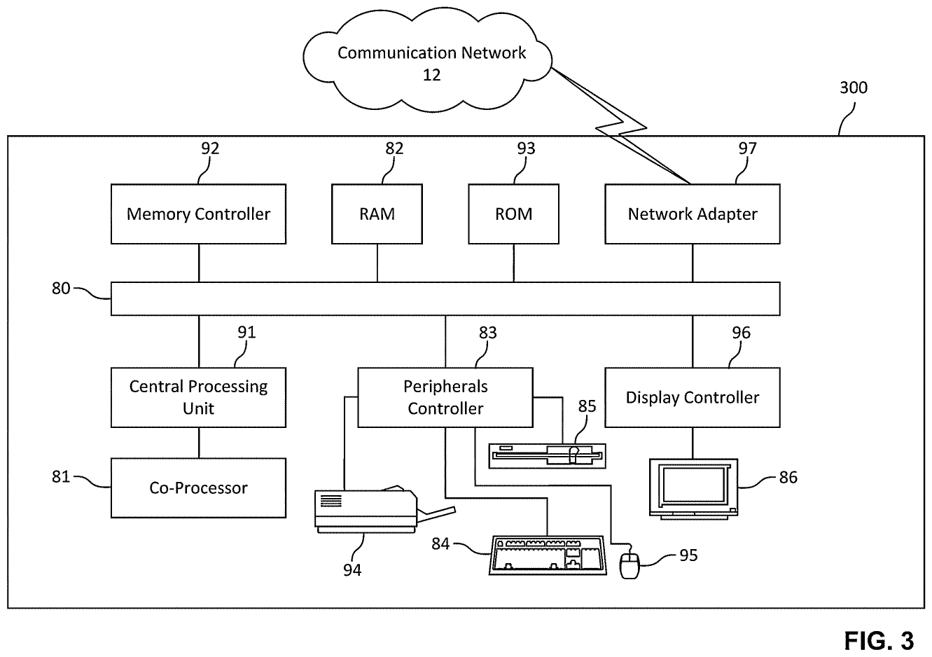

FIG. 3 is a block diagram of an exemplary computing system 300, in accordance with various aspects of the present disclosure. In some examples, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

Various aspects of the present disclosure are generally directed to systems and methods for smart media generation using generative artificial intelligence (AI). Examples of the present disclosure may include the use of generative AI to generate photorealistic media (e.g., image or video) comprising a likeness of a user that may capture the imagination of users via an input.

As an example, a user may use the generative AI to create media from text (e.g., an input) by using a “command” (e.g., /imagine), both in user-to-user chats and in a chat with an AI chatbot. In an example, a user may utilize generative AI by providing an input and the command in a platform (e.g., a messaging platform, social media platform, or the like). The platform may utilize and/or be associated with generative AI. The input may be any suitable string of text, for example, “Imagine me as an Anime character.” The AI may assess context associated with the input and generate a media item representative of the input. In some examples, the generative AI may provide a list of media items, where the user may choose which media item out of the list of media items best fits the input associated with the user.

In a particular example, the generative AI may be configured to utilize an image of the user to generate media, where the image of the user (e.g., data associated with the image) and the input may be utilized to effectuate the generated media (e.g., generated media based on the input may resemble the likeness of the user). In some examples, the input may comprise an initiator, the initiator may be a set of words or a string of text that may notify the generative AI system that the user is requesting media to be generated that may resemble the likeness of the user. The initiator may be text such as, but not limited to, “me,” “myself,” or the like.

In an example, the generative AI may utilize the following functionality: in-thread promo, consent, sharing, and feedback. In-thread promo may be a promotion to use the generative AI within any suitable platform (e.g., messaging app, third-party app, chat room, or the like). Sharing may allow a user to share a generated media item to one or more users of a plurality of users associated with the user. Feedback may allow for conventional long-press reactions to a generated media item so that another user may react to the photo via emoji, reply, save the image, forward the image, or the like. The feedback may also comprise AI feedback options, where the user or another user in contact with the user may determine or provide a decision on the image, i.e., whether the media item was a good or bad response in regard to the input that was provided by the user. Consent may be a pop-up menu or dashboard prompting the user with information regarding the use of the generative AI, where the user may decline or accept the use of generative AI. Consent may be performed or achieved via a process 500, to be further described in the following paragraphs.

As discussed, various aspects of the present disclosure are directed to generating media using a generative artificial intelligence (AI) model in conjunction with user-provided likeness data. The invention enables the generation of personalized media based on prompts that reference the user and/or other identified subjects, such as friends, family members, pets, or objects. In some examples, reference image data may be associated with distinct entities in a private memory architecture. In some such examples, the private memory architecture may persistently store identity-linked image data and metadata for use in future prompt processing.

Upon detecting a prompt that includes a reference to the user's likeness (e.g., an initiator such as “me” or “my dog”), the system determines whether the user has previously provided consent and completed the capture process. If not, the system initiates a multi-step onboarding procedure, including real-time image capture with liveness verification (e.g., head movements, facial gestures) to prevent impersonation or spoofing. The invention also supports extended capture, allowing users to supplement their real-time captures with additional images (e.g., higher-quality or professionally captured images) from their camera roll and/or social media profiles. These extended images may be verified through facial embeddings or other biometric techniques and labeled with identifiers (e.g., “my daughter”) for future reference.

Captured likeness data is stored in a private memory store associated with the user's profile. This store can persist over time and support dynamic recall of a user's likeness whenever referenced in a prompt. In some examples, a user may populate their private memory not only with images of themselves but also with images of others, such as their children, pets, or close contacts. These labeled entities may be referenced at inference time to generate composite images including multiple subjects (e.g., “me and my spouse at the beach”).

In some examples, a permission-sharing model is used to govern access to stored likeness data across users. In some such examples, each user may grant explicit permission for others (e.g., friends, mutual followers, or specific individuals) to reference their likeness in generative prompts. If a prompt references a third party (e.g., “me and user A”), the system checks whether the requesting user has permission to access the referenced individual's likeness from that individual's private memory. If access is denied, the system may suppress or alter the output accordingly. This allows for secure, consent-based co-generation of media featuring multiple distinct individuals.

In some examples, optional authentication mechanisms may be applied when storing third-party likeness data. For example, a user may use their own device to capture their child's likeness, with or without liveness checks or supporting documentation (e.g., identification). The platform may allow or restrict such features depending on the regulatory environment or user-configured trust settings. While authentication was historically a core focus to mitigate deepfake risks, the system is adaptable to evolving requirements and may relax or reinforce authentication based on policy, risk profile, or entity type (e.g., no authentication required for pets or fictional characters).

Taken together, various aspects of the present disclosure provide a robust, flexible, and privacy-aware framework for personalized media generation using generative AI. As discussed, users may persistently store likeness data in a private memory, label and manage entities within that memory, and control who may access and invoke those likenesses for generation purposes, all while offering optional layers of authentication and verification tailored to real-world usage and risk conditions.

In the present disclosure, a private memory store may be an example of a user-specific data structure configured to store (e.g., persistently store) visual or biometric reference data, such as images, video frames, or embeddings, associated with identifiable subjects. These subjects may include the user themselves, as well as other entities explicitly labeled and stored by the user (e.g., a child, pet, spouse, or friend). The private memory store enables personalized and context-aware media generation using generative AI models. The private memory store may be associated with one or more memory units on one or more user devices and/or cloud-based memory units.

The private memory store operates as a long-term repository that retains the identity and appearance data captured during onboarding and extended capture processes. Once a likeness is captured and verified (e.g., through real-time liveness detection or biometric comparison), the data is indexed and linked to a user profile or entity label (e.g., “my dog”). This allows the system to later retrieve the corresponding likeness data during inference, in response to natural language prompts like “me at the beach” or “me and my daughter at a picnic.” In some examples, the private memory store is permission-aware and user-controlled. Each user may define who can access the likenesses stored in their private memory. These access rules form the basis of the permission-sharing model, which governs whether and how other users may reference a stored likeness in their own generative prompts. For example, if User A references “User B” in a prompt, the system will query User B's private memory store and validate whether User B has granted User A permission to use his likeness. If not, the system may decline the request or omit the likeness from the output. In some examples, the private memory store may also include metadata such as capture source (real-time or extended), timestamps, verification status, and confidence scores. This data may be used to assess the quality or trustworthiness of a likeness, or to prioritize which stored images are used during generation.

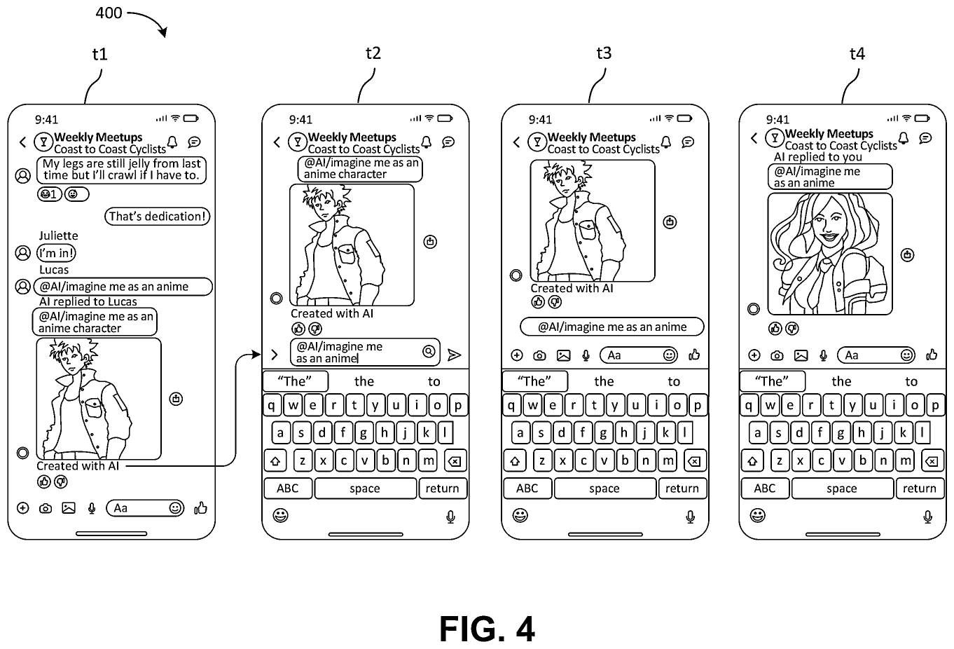

FIG. 4 is a diagram illustrating an example user interface flow 400 for generating AI images in a messaging context, in accordance with various aspects of the present disclosure. In the example of FIG. 4, the AI-generated images may be generated in response to natural language prompts that reference the user's likeness. The example of FIG. 4 shows a sequence of four different time points, t1, t2, t3, and t4, demonstrating how a generative AI system can operate within a social or group messaging platform to generate and display media content in response to user inputs. During that flow, the system may have conducted identity verification using real-time liveness detection, such as head movements, gaze shifts, or facial gestures, to ensure the captured images correspond to the actual user and were not spoofed using static or prerecorded content. Additional or alternative verification may include comparing extended image uploads against real-time capture via face embeddings or biometric scoring.

As shown in the example flow 400 of FIG. 4, at time t1, the display shows a chat interface titled “Weekly Meetups” in which multiple users, including “Juliette” and “Lucas,” are participating. Within the chat thread, user Lucas enters the prompt “@AI/imagine me as an anime character.” This prompt is a natural language command invoking the generative AI assistant to generate an image of the user as a stylized anime character. The system detects the initiator phrase “me,” indicating that the prompt is referencing the likeness of the user who submitted the message. In response, the generative AI system accesses the user's previously captured and stored likeness data, e.g., from the user's private memory store, and initiates the image generation process. An AI-generated anime-style image is rendered and posted into the chat as a system-generated reply, labeled “Created with AI.”

At time t2, the interface shows another instance where the same user enters the same or a similar prompt into the input field, “@AI/imagine me as an anime.” This illustrates the AI system's ability to process repeated or slightly modified prompts from the same user, potentially resulting in different renderings due to prompt variation, randomness in the generative model, or updated user preferences. The display reflects that the user is in the process of entering the command, and the system is ready to process a new generation request.

At time t3, the generative system has completed another rendering of the user's likeness in anime form. This image appears different from the previous output at t1, demonstrating diversity in output generation even with similar input prompts. This variability may be driven by random seed selection, underlying diffusion model behavior, or prompt interpretation logic. The AI-generated image is again inserted into the chat and labeled as “Created with AI,” confirming to all participants that the image is machine-generated and based on the initiating user's likeness data retrieved from private memory.

At time t4, the interface shows that the AI has responded to a new user's prompt, “@AI/imagine me as an anime,” suggesting that a second user (distinct from Lucas) has invoked the AI assistant. The generated output in this instance is a distinctly different anime-style rendering, reflecting the unique likeness of the second user. The system likely accessed a different private memory store linked to this second user to retrieve appropriate reference data. As with previous instances, the response is labeled as “Created with AI” and is threaded as a reply to the user's original prompt.

Collectively, FIG. 4 illustrates an example of the integration of the generative AI system within a multi-user chat environment. The flow 400 of FIG. 4 also shows examples of parsing of natural language prompts containing initiators (e.g., “me”) to determine whether stored likeness data should be retrieved, referencing the individual users' private memory stores to personalize the generated media, the dynamic generation and rendering of AI-created images based on textual prompts; and the system's ability to manage and distinguish multiple users within a shared conversational thread while generating user-specific content.

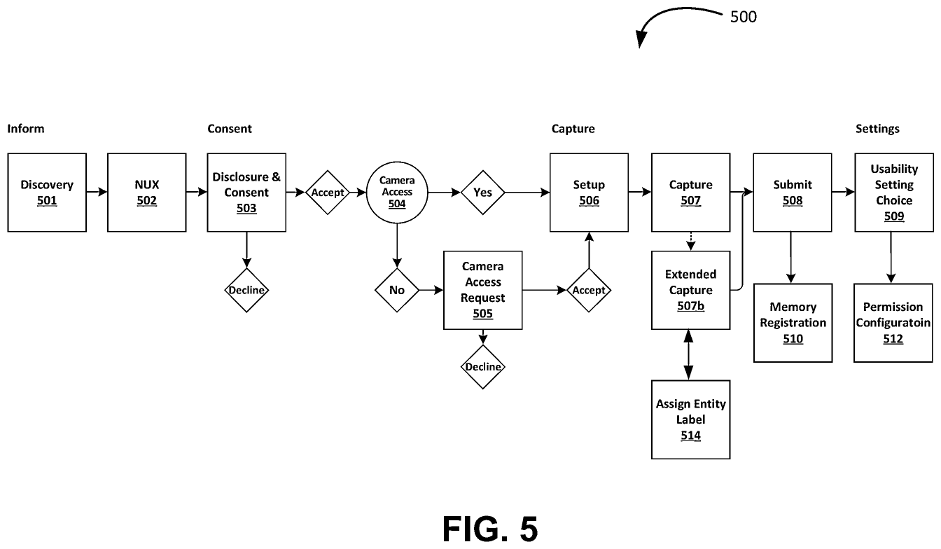

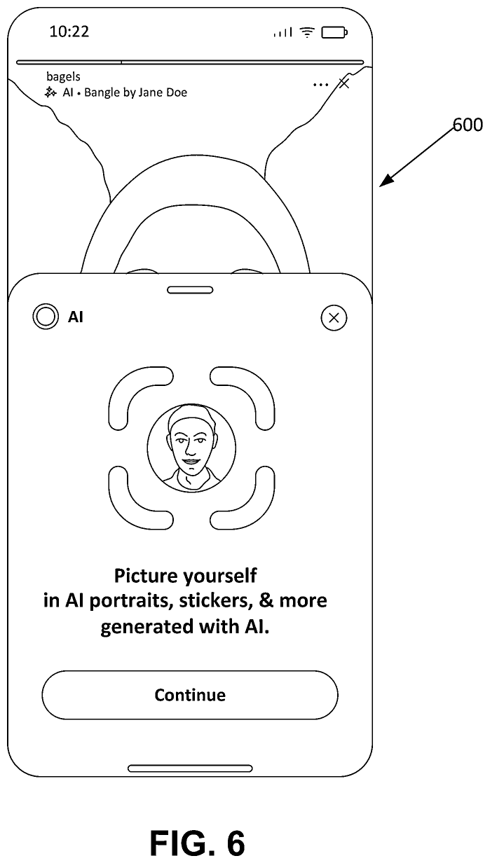

FIG. 5 is a block diagram illustrating an example of a process 500 for generating AI images, in accordance with various aspects of the present disclosure. FIGS. 6, 7, 8, 9, 10, and 11 are diagrams illustrating examples of graphical user interfaces 600, 700, 800, 900, 1000, and 1100, respectively, in accordance with various aspects of the present disclosure.

In some examples, an initiator may prompt a user to provide consent to the generative AI to generate media that may resemble the likeness of the user. Consent may be provided to the generative AI via the process 500 described with reference to FIG. 5. In some examples, the process 500 may comprise a number of steps to obtain user consent, capturing one or more images of the user, or the like. Consent may be obtained at any moment while utilizing a platform that may use generative AI. The user may provide consent via settings associated with the platform (e.g., social media platform, messaging platform, user device settings, or the like). The user may be prompted (e.g., via a pop-up menu, dashboard, or the like) to provide consent via the process 500 as a response to generative AI receiving an input that comprises an initiator. As shown in FIG. 5, the process 500 may begin with a discovery 501. The discovery 501 may be a determination via generative AI that the input comprises an initiator. Discovery 501 may comprise determining whether a user has provided consent to generative AI to utilize associated with the appearance of the user. When the user has provided consent, the user may proceed to generate a media item via generative AI that may resemble the user's likeness. For example, when the user has not provided consent, the process 500 may continue to NUX 502. At NUX 502 the platform may provide a landing screen to a user via a user device. The graphical user interface 600, described with reference to FIG. 6, may be an example of the graphical user interface provided by a NUX 502. At the NUX 502 the user may determine how to proceed with the process 500. The landing screen may comprise a brief description of the media creation (e.g., what the generative AI may be able to do with data associated with the user's appearance), where, based on the description, a user may determine whether they are interested in generative AI using user likeness to generate a media item.

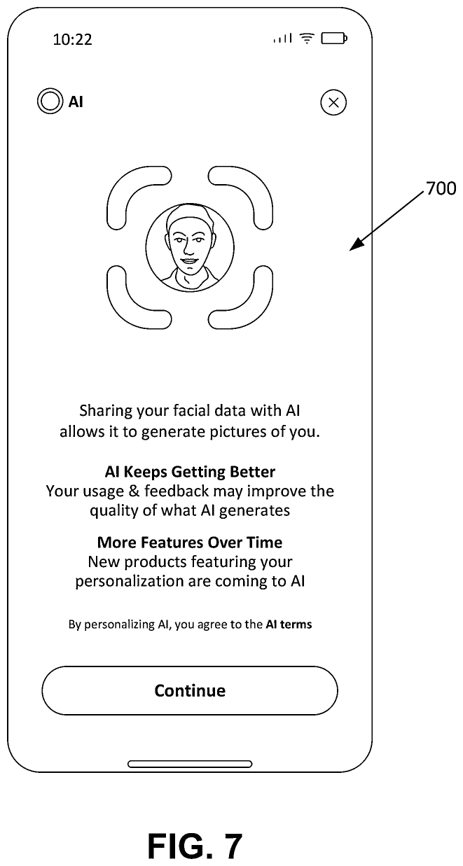

The user may be provided a disclosure and consent 503 via a graphical user interface. In some examples, the disclosure and consent 503 may be a set of text that provides the user information on what data may be captured during usage of generative AI, for example, disclosure and consent may provide a user with information on how the data needed for this implementation (e.g., generating media associated with user likeness) of generative AI may be used. Disclosure and consent 503 may be accepted or declined, when a user declines disclosure and consent 503, the process 500 may end. FIG. 7 may illustrate an example disclosure and consent 503 provided to a user via a graphical user interface 700. When a user declines disclosure and consent 503 the user may not utilize generative AI to generate media that resembles the likeness of the user, that user may change the response to disclosure and consent 503 by starting process 500 again or via settings. When a user accepts disclosure and consent 503, the platform may assess whether it has been granted access to utilize a camera (e.g., access 504) associated with a user device. In an example, when the platform does have access to utilize the camera (e.g., camera access 504), the process 500 may proceed to capture 507. Conversely, when the platform does not have access to utilize the camera, the platform may request access to the camera (e.g., camera access request 505). Access request 505 may be a notification, pop-up, or the like that may provide a user to select whether to provide the platform with access to the camera. When a user declines an access request 505, the process 500 ends. When the user accepts the access request 505, the process 500 may continue to the setup 506 stage.

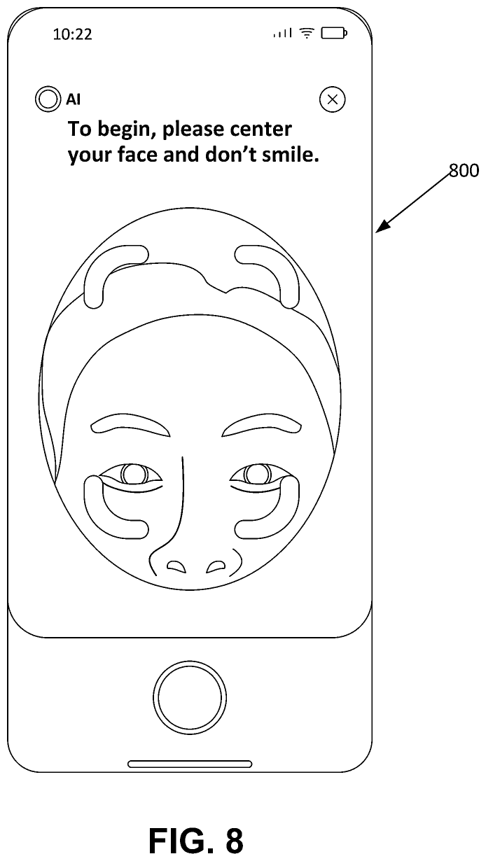

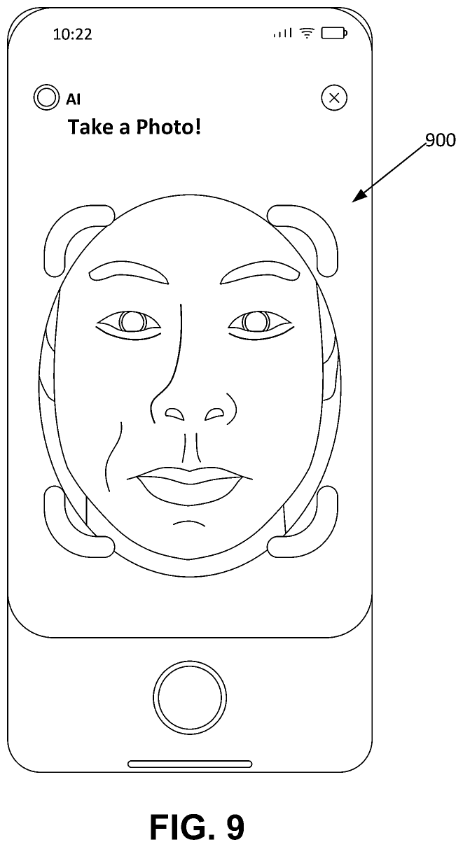

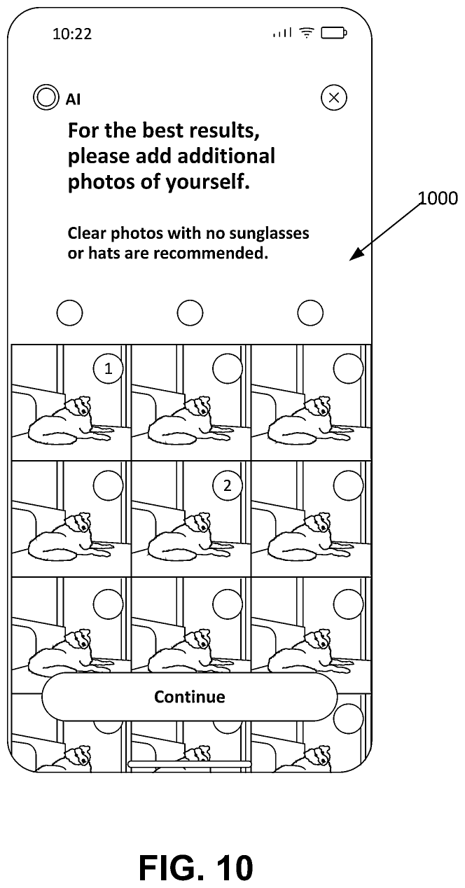

At the setup 506 stage, the platform may provide a set of instructions to the user to begin taking one or more images of the user. The set of instructions may be configured to provide instructions to the user on how to position the camera (e.g., front camera facing the user) such that one or more images may be captured. Setup 506 may be illustrated by the graphical user interface 800 of FIG. 8. At capture 507, the platform may receive one or more images of the user to obtain images and data necessary to generate a media item that may resemble the likeness of the user, as illustrated by the graphical user interface 900 of FIG. 9. It is contemplated that capture 507, in some examples, may be associated with the capture of a video, audio, or any combination thereof. In some examples, the process 500 may allow for a user to provide additional images (e.g., extended capture 507b) of themselves, non-human beings (e.g., a pet, an animal, an object, or the like), as illustrated in FIG. 10 with graphical user interface 1000. Additional images may be one or more images determined by the user, the additional images may comprise images posted to a platform (e.g., social media platform, messaging platform, or the like) or images saved on a user device. The platform may be configured to communicate with a user device to receive one or more images stored (e.g., cloud, native storage, or the like) that the user may choose to utilize to create generative media. In such examples, the user may be able to assign an initiator for other beings, such as, but not limited to, “my dog,” “my pet,” or the like. In some examples, capture 507 may comprise capturing one or more images of a user at various head or facial positions (e.g., tilt, rotated, turn, or the like of some varying degree).

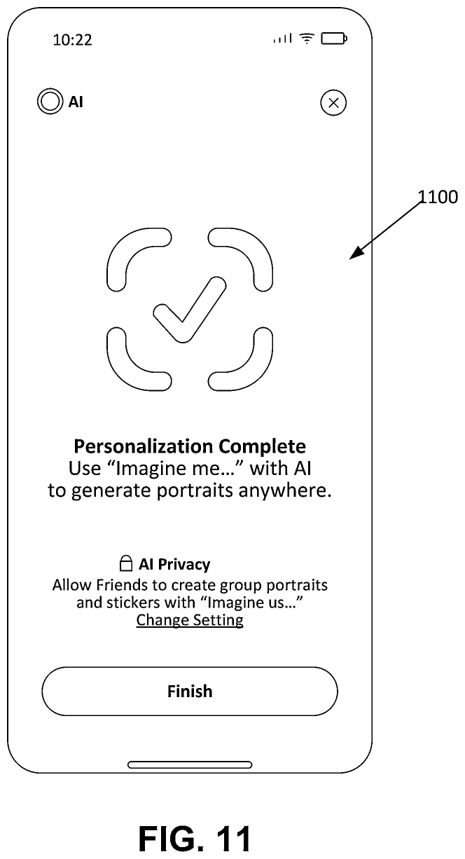

In some examples, the user may submit 508 the one or more images to the platform, where the platform may receive and store data associated with the one or more images taken at capture 507. The data may be stored in a database, wherein the data associated with the one or more images may be stored and associated with a user profile associated with the user. In some examples, submit 508 may occur automatically following the capture 507 of one or more images. Conversely, in some alternate examples, submit 508 may be initiated via a button press on a graphical user interface. As a result of the platform receiving and storing the one or more images, consent choices may be stored in a database associated with the platform. Following submit 508, a completion screen may be provided to a user, as illustrated in graphical user interface 1100 of FIG. 11. In some examples, the platform may provide via settings (e.g., usability setting choice 509) an indication of whether consent was approved, or generative AI is capable of generating media utilizing the likeness of the user. It is contemplated that consent given to generative AI to utilize a user's likeness may be withdrawn at any time via settings associated with the platform. It is contemplated that a user may update their capture data (e.g., data associated with the capture 507 of one or more images) at any time via settings associated with the platform.

As discussed, FIG. 5 illustrates a process 500 to obtain informed consent and capture appearance data. In some examples, the process 500 may also populate and maintain a private memory architecture, such as a persistent, user-specific data structure configured to store, index, and retrieve verified visual and biometric likeness information associated with one or more user profiles. This private memory architecture enables future invocations of a user's likeness in conjunction with generative artificial intelligence (AI) media generation models and incorporates configurable access controls to support dynamic and privacy-aware usage.

As discussed, the process 500 initiates at discovery 501, where the system analyzes a user input (e.g., a text prompt) to determine whether the input includes an initiator, such as the terms “me,” “myself,” or other identifiers, that signals an intent to generate content featuring the user's likeness. Upon detecting such an initiator and determining that the user has not yet granted consent, the system proceeds to NUX 502, which presents a graphical user interface (GUI) that introduces the capabilities of the generative AI system. This introductory step serves to educate the user on the media generation features and sets expectations for how the system will handle visual data.

At disclosure and consent 503, the user is presented with a unified consent interface that details the platform's data usage policies, privacy practices, and terms of use specific to AI-generated likeness. In some examples, the consent interface may be optional. In some jurisdictions, such as Illinois or Texas, localized disclosures may be provided in compliance with state-specific biometric information privacy laws. If the user accepts these terms, the system proceeds to verify camera access at camera access 504. If access has not yet been granted, the system triggers a request through the camera access request 505. Denial of access at this stage results in termination of the process.

Upon receiving camera access, the process 500 continues to setup 506, wherein the user receives guided instructions for capturing high-quality, verifiable images. These instructions may include prompts for positioning, facial expressions, and controlled head movements (e.g., tilting, turning), thereby supporting liveness detection and reducing the risk of impersonation via static photos or prerecorded videos. The process 500 then advances to capture 507, where the platform acquires one or more real-time images or videos of the user.

The process 500 optionally supports extended capture 507b, which allows the user to provide additional images from their device's camera roll or from social media platforms where they are tagged. To maintain integrity, extended images may be cross-referenced with live captures using facial embeddings or other biometric comparison techniques. In connection with extended capture, the process may also include an assign entity label 514 step, enabling the user to tag uploaded likenesses with entity-specific labels (e.g., “my daughter,” “my cat,” “Jack,” or “my car”). These labels may be subsequently used to resolve natural language prompts during AI inference (e.g., “me and my dog at the park”).

Upon completion of the capture process, the process 500 reaches submit 508, wherein the acquired data is transmitted and committed to a back-end system for long-term storage. At this point, the system proceeds to memory registration 510, which denotes the formal enrollment of the appearance data, including metadata such as timestamps, source type (real-time vs. extended), device identifier, and verification confidence, into the private memory store associated with the user's profile. This persistent memory allows future AI processes to retrieve and apply the user's likeness in response to compatible prompts, eliminating the need for repeated capture events.

Following memory registration 510, the process 500 invokes usability setting choice 509 and permission configuration 512, which together define the permission-sharing model governing who may access and reference the stored likeness. Usability settings may offer predefined tiers, such as, but not limited to, “no one,” “close friends,” “mutual followers,” or “everyone,” and may be further customized via user-defined exception lists or blocking configurations. These controls may be enforced at generation time, such that if User A references User B's likeness in a prompt (e.g., “me and Jack having coffee”), the system consults User B's permission settings to determine whether such access is authorized.

In some examples, a user may revisit and update these usability settings at any time via an interface. For example, the user may revoke previously granted access, add or remove capture data, and modify permission preferences on a per-entity or per-user basis. Collectively, these steps ensure that the user retains meaningful control over how their likeness is captured, stored, and used in generative AI applications. Accordingly, the process 500 accommodates both single-user and multi-user interactions and supports per-entity tagging, permission customization, and persistent memory registration. The process 500 may be implemented in various social platforms, messaging environments, and avatar-based ecosystems where collaborative generation and personalized identity representation are essential.

In accordance with various aspects of the present disclosure, the consent and capture framework may ensure that users are fully informed and in control of how their likeness is captured, stored, and used in connection with a generative AI system. The process supports various modes of pre-capture discovery, including prompt-based activation (e.g., when a user includes “me” or “us” in a generative prompt), mimicry-based discovery (e.g., when a user sees another user's AI-generated likeness and chooses to participate), and third-party-based discovery (e.g., when another user references someone's likeness in a generated image). The third-party-based discovery may also be referred to as invoke-based discovery. In some examples, discovery may also be initiated through curated, first-party template prompts made available via platform-integrated tools.

The consent and capture surface may be triggered in either a native application environment or through a browser-based interface. In either case, initiating the process launches an interactive experience that walks the user through each required step. Pre-capture education may include single-user messaging that explains the benefits of completing the process (e.g., enabling personalized image generation) as well as two-user education informing individuals that, if they reference others in prompts, those individuals must also complete the process for their likeness to be included.

During the consent phase, users are asked to agree to AI-specific disclosures, terms of service, and, if applicable, terms permitting the use of capture data for training the generative AI models. Declining any of these terms results in termination of the process. Consent is not limited to agreeing to platform terms; consent may also include the configuration of usability settings.

Users may be informed that they can control who may reference their likeness in AI-generated media, and are presented with configurable options: no one, specific individuals (e.g., selected friends), all mutual followers/friends, or everyone. Even when the “everyone” option is selected, users may designate specific individuals as blocked, ensuring granular control over likeness usage.

Pre-capture setup includes system prompts to secure camera access permissions if not already granted. Once authorized, the user is guided through subject and environmental setup, including proper framing, lighting, facial accessory adjustments, and camera orientation. The capture process itself is designed to be intuitive and user-friendly, with interactive prompts and a progress bar to indicate completion status. After each real-time capture, users can preview their images and have the opportunity to recapture as many times as desired.

In some examples, the system uses two or more real-time capture images, taken in different poses, to serve as a baseline for identity verification and likeness modeling. Optionally, users may participate in extended capture, which allows for supplemental image data to be submitted. This includes real-time extended capture beyond the baseline set, as well as image selection from the user's camera roll or tagged images from social media accounts. All extended data is intended to improve generation quality and likeness accuracy.

The process may also incorporate a set of integrity controls to prevent the misuse of the system. Specifically, the platform may not process image data from non-consenting individuals, nor will it allow harmful, offensive, or explicit material that violates platform standards to be ingested or used in AI generation. As discussed, captured data may be stored in a private memory architecture, a persistent, user-specific storage layer that associates verified likeness data with the user profile. This memory module may be used during prompt processing to retrieve reference images when the user, or an authorized third party, invokes an entity label such as “me,” “my daughter,” or “User A” (e.g., a third-party). The private memory system may be integrated with the permission-sharing model, meaning access to a user's stored likeness data is conditioned on the user's selected usability settings. When a prompt includes multiple participants, the system checks each individual's permissions before rendering the composite image. If access is denied, the system may exclude that entity from generation or substitute a placeholder.

Users retain full control of their data through the AI data and settings interface, available via both web and native app experiences. Within this interface, users can view, update, or delete their capture data; recapture their likeness; add additional extended data; and adjust their usability settings at any time. Deletion of minimum required capture data results in loss of generative functionality, ensuring that user consent is not only meaningful but functionally enforced. This framework provides transparency, consent, and control at every stage of participation, while enabling personalized, high-quality image generation in both single-user and collaborative scenarios.

Following onboarding (e.g., via process 500), users may be provided access to a comprehensive AI settings interface that enables ongoing control over their likeness data and sharing preferences. This interface allows users to manage both their capture data, e.g., the appearance information collected during initial and extended capture, and their usability settings, which define how and by whom their likeness can be accessed and used for generative media.

Within the AI Settings, users may view and modify their usability settings across any platform where generative AI features are available. These settings include configurable tiers of access such as: “Everyone,” allowing any user to reference the stored likeness in generated content; “Friends,” permitting only mutual followers (e.g., followers on one or more social media platforms) to reference the user's likeness; “Specific People,” where users may create a custom whitelist of authorized individuals; and “Only Me,” which restricts likeness usage solely to the originating user. Notably, even if the setting is configured to “Everyone,” users may still block specific individuals to prevent unauthorized referencing of their likeness.

The usability settings may be associated with the permission-sharing model within the system's private memory architecture. When a user or their AI assistant submits a prompt that includes one or more referenced entities, such as “me and User A at the beach,” the system checks the private memory of each referenced subject and consults their sharing permissions. If the subject has not authorized the requesting user, the system may suppress, deny, or replace that portion of the image request to preserve privacy and data integrity. This applies equally to users and non-user entities (e.g., pets, labeled objects) stored within a user's memory.

In addition to permission controls, the AI settings may allow users to manage their capture data, also referred to as AI personalization data. Users may add, edit, or delete images collected during real-time capture, as well as supplementary images sourced from their camera roll or imported from social media accounts. If a user attempts to delete data such that their total stored images fall below a defined minimum data threshold, the platform will display a warning and may temporarily disable likeness-based media generation features until the threshold is reestablished.

The AI settings also support entity-based labeling and extended memory management. For example, a user may store labeled likenesses of third parties, such as “my daughter,” “my dog,” or “User A,” and reference them in prompts (e.g., “me and my dog at the park”). These entities may be authenticated through optional mechanisms, such as in-person live capture on the user's device or via shared devices. While the system may support identity verification via liveness detection (e.g., movement prompts), the system does not require this in all cases. For example, pets or stylized avatars may be stored and referenced without authentication. In some implementations, another user may also grant permission to access their private memory store, enabling co-generation scenarios such as “me and User A having coffee,” even if User A's likeness is stored only in his own profile and not in the requestor's.

Users may access additional tools through a help center, which is linked from within the AI Settings interface. The help center may provide educational content explaining why the capture process is required, how to manage and delete stored data, and how to adjust usability permissions. The help center may also include frequently asked questions, explanations of permission levels, and best practices for tagging and referencing entities.

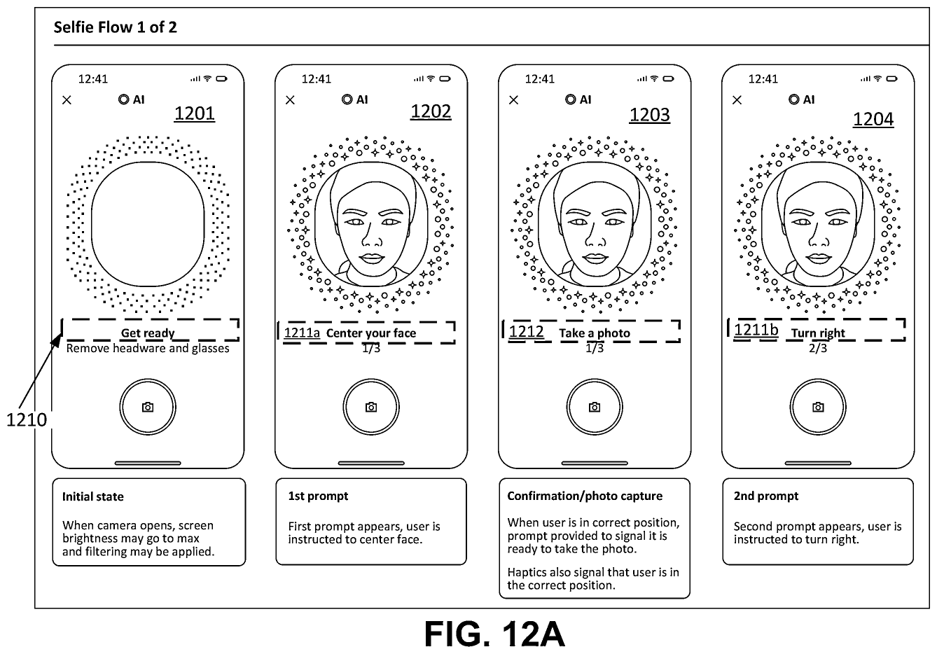

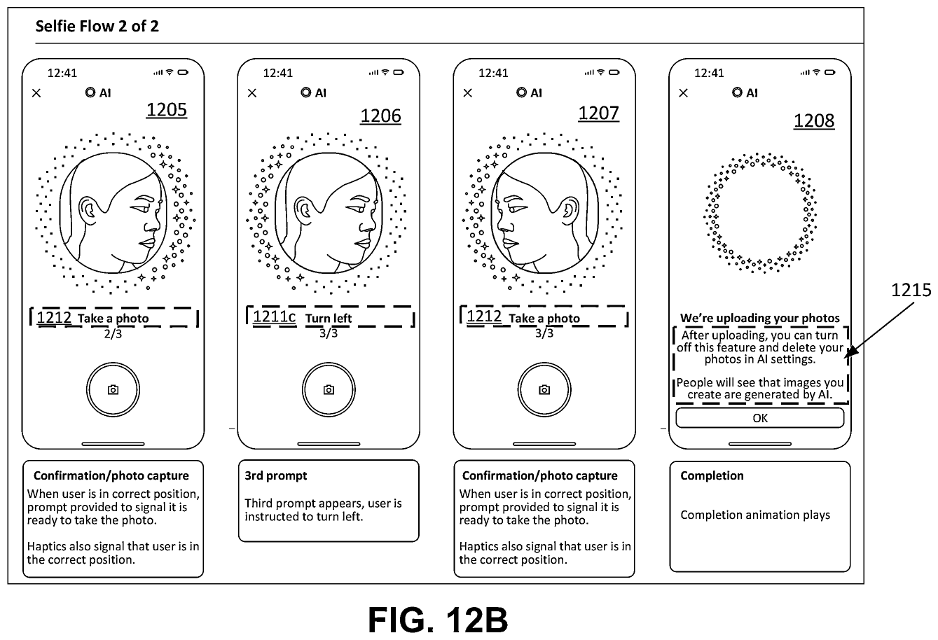

FIG. 12A and FIG. 12B illustrate examples of graphical user interfaces 1201, 1202, 1203, 1204, 1205, 1206, 1207, 1208, in accordance with various aspects of the present disclosure. Specifically, FIGS. 12A and 12B may provide further detail on setup 506 and capture 507 of the process 500 described with reference to FIG. 5. The graphical user interfaces (e.g., graphical user interface) of FIG. 12A and FIG. 12B may illustrate some examples of a set of instructions. The set of instructions may be configured to aid a user on how to begin (e.g., setup 206) taking one or more images associated with capture 207 and head or facial positioning associated with taking one or more images associated with capture 207 of the process 200. The set of instructions may include, but not limited to, a positioning prompt 1211a, 1211b, and 1211c (e.g., “center your face”), a prompt 1212 (“e.g., take photo”), a welcome message 1210 (e.g., “get ready”), guidance (e.g., “remove hardware and glasses”), or the like. In some examples, the platform may trigger the user device brightness to increase at setup 206, as illustrated with the graphical user interface 1201. The platform may apply a filter to the view of the user on the graphical user interface. The graphical user interface 1202 may illustrate a first positioning prompt 1211a (e.g., “center your face”). A prompt 1212 (e.g., “take a photo”) may be illustrated with the graphical user interface 1203. In an example, when the prompt 1212 is provided to a user, the user may press a button on the graphical user interface to take a photo. In an example, the platform may automatically capture an image of the user when the prompt 1212 is presented (e.g., provided to the user). The prompt 1212 of the graphical user interface 1203 may be provided to the user when the user is in the correct position, as instructed with the first positional prompt 1211a of the graphical user interface 1202. In response to the user being in the correct position the platform may communicate with the user device to perform a haptic feedback (e.g., vibration) to signal to the user that they are in the correct position. A second positional prompt 1211b (e.g., “turn right”) may be illustrated with the graphical user interface 1204. Again, when the user is in the correct position relative to the second positional prompt 1211b, the prompt 1212 (e.g., “take photo) may be provided to the user, as illustrated by the graphical user interface 1205. The process of head or facial movement after receiving a positional prompt 1211 (e.g., third positional prompt 1211c), confirmation of correct positioning by via haptic feedback and a prompt 1212, and taking the image (e.g., user pressing a button on graphical user interface to take image or platform automatically capturing image) may be repeated any number of times based on the data needed for the generative AI to create a media item associated with the likeness of the user, this may be illustrated with graphical user interface 1206 and graphical user interface 1207. Following the capture of all necessary data (e.g., associated with the capture of one or more images) for the AI to generate a media item that may resemble user likeness, the user may be provided a completion screen (e.g., graphical user interface 1208). The completion screen may inform the user that the images captured are being uploaded (e.g., sent and stored in a database). The completion screen may also provide the user with upload information 1215.

Generative AI, as referred to herein, may be referred to as a generative AI model, which may comprise one or more machine learning models. The generative AI model may be configured to utilize a reference image (e.g., one or more images taken via capture 507) and an input (e.g., comprising an initiator) to generate a media item (e.g., a synthetic image) that may resemble the user. The input may include, for example, complex prompts to generate images with diversity. Diversity may include, but is not limited to, head and body poses, facial expressions, and layout.

The generative AI model may be a diffusion model that progressively converts random noise into a structured output, such as an image or audio clip, through a series of learned steps. The architecture of a diffusion model may be centered around a deep neural network, which may use convolutional layers when dealing with images, or recurrent layers for sequence data like audio or text. The operation of the model may include two primary phases: the forward diffusion process and the reverse generative process. In the forward diffusion, the model may gradually add noise (e.g., Gaussian noise) to the data over a series of timesteps, transforming the original data into pure noise. This is done in a way that each step of adding noise is statistically tractable, allowing the model to learn how the data is being corrupted at each timestep.

Diffusion models may be generated based on the concept of knowledge distillation, where the goal is to transfer knowledge from a complex model (teacher) to a simpler model (student). Training a student diffusion model through the process of distillation begins with the generation or accessing of a well-trained, high-performance teacher model. The teacher model may have already learned how to effectively perform the task at hand, such as image generation, through a series of forward (e.g., adding noise) and reverse (e.g., removing noise) diffusion steps, as described above. In some embodiments, the teacher model may be a pre-trained model.

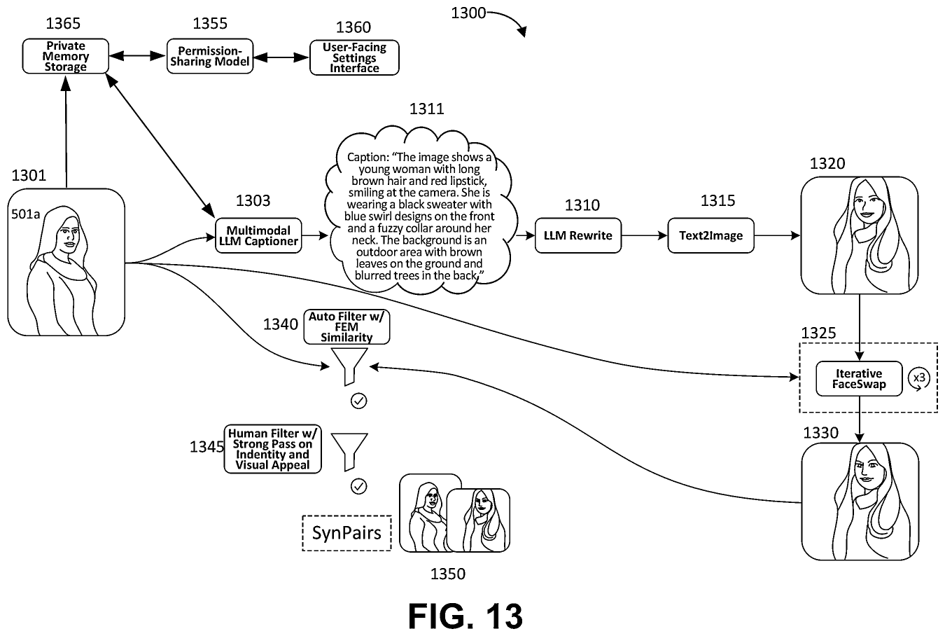

FIG. 13 illustrates an example system architecture 1300 for generating a media item (e.g., a synthetic image), in accordance with various aspects of the present disclosure. As shown in the example of FIG. 13, the system 1300 may employ one or more machine learning (ML) models associated with a generative AI model to curate large-scale, high-quality, paired data (same identity with varying expression, pose, and lighting conditions, etc.).

In an example as illustrated in FIG. 13, a source image 1301 (e.g., reference image (e.g., one or more images taken via capture 507)) may be received at a first trained machine learning (ML) model 1303. In some examples, the source image 1301 may contain a subject 1301a (e.g., a user) with an identity distinct from other objects. In other examples, the source images 1301 may contain multiple subjects 1301a-1301z, of which one subject is analyzed by the first trained ML model 1303. For example, subject 1301a may be associated with a user and subjects 1301b-z may be associated with objects in a room (e.g., a desk, a table, or any other suitable object, pet, being, or the like) where the first trained ML model 1303 may analyze the subject 1301a (e.g., the user).

Next, the first trained ML model 1303 may analyze the source image 1301 (e.g., reference image (e.g., one or more images taken via capture 507)) to extract data. The first trained ML model 1303 may include a Deep Learning Inference Framework (DLIF). In an example, the data may include data points associated with the appearance of the user, without the use of facial recognition.

In some examples, the data may include a first caption 1311 indicative of the subject 1301a in the source image 1301, for example, the caption may describe the subject 1301a. For example, the caption may indicate that the image(s) show “a young woman with long brown hair and red lipstick, smiling at the camera. She is wearing a black sweater with blue swirl designs on the front and a fuzzy collar around her neck. The background is an outdoor area with brown leaves on the ground and blurred trees in the back.”

In an alternate example, the first caption 1311 may also include a modifier related to the subject 1301a in the source image 1301. The modifier may provide details about the subject's appearance or some type of action. For example, the modifier represented in italics may indicate, “a young woman with long brown hair and red lipstick, smiling at the camera while dunking a basketball in a hoop.”

Subsequently, as illustrated in FIG. 13, the first caption 1311 is received by a second trained ML model 1313. The second trained ML model 1313 is configured to update the first caption 1311 by injecting more gaze and pose diversity. In so doing, the second trained ML model 1313 outputs a second caption. For example, the second caption (not depicted) may enhance an attribute of the first caption 1311 by including less noise or by presenting a different perspective. In some examples, the second caption may result in more diverse gaze and pose variations. This may aid in creating a more accurate and refined description of the subject for the subsequent image generation process. For example, the second caption with enhancements in italics may indicate, “a young woman with long brown hair parted from the front and red lipstick, smiling with no visible teeth at the camera.”

Next, the second caption, e.g., updated caption of the first caption 1311, may be fed to a text-to-image generation unit 1315. The text-to-image generation unit 1315 subsequently outputs a high-quality, intermediary synthetic image 1320 indicative of the second caption. The intermediary synthetic image 1320 may include a trait (e.g., likeness) associated with the source image 1301. For instance, the intermediary synthetic image 1320 may have similar soft-biometric traits such as skin tone, hair, age, gender, or the like as the source image 1301.

As further illustrated in FIG. 13, the intermediary synthetic image 1320 is received by a face swap unit 1325. The face swap unit 1325 injects the identity of the subject 1301a in the source image 1301 into the intermediary synthetic image 1320. In some examples, this process may be iterated one or more times. For example, the process may be iterated three times. In doing so, it is envisaged that the final synthetic image 1330 (e.g., a media item) exhibits an improvement in identity preservation and image quality. That is, the outputted final synthetic image 1330 (e.g., a media item) may accurately represent the subject's 1301a identity and characteristics.

In some examples, as shown in FIG. 13, the final synthetic image 1330 (e.g., a media item) and the source image 1301 are subsequently transmitted to, and received at, one or more filters 1340 (and 1345). As depicted in FIG. 13, there are two filters. It is contemplated that there may be any number of filters associated with the architecture 1300. In some examples, the filtering process may continuously occur. That is, multiple final synthetic images (e.g., plural media items) and their associated source images (e.g., of the same subject or different subjects) may be transmitted to one or more filters. Alternatively, filtering may occur in batch mode upon receiving multiple final synthetic images and their associated source images.

In an example, the one or more real and synthetic images (e.g., media items) are run through the one or more filters 1340 (and 1345) to assess arc face similarity, identity, and/or visual appeal. In an example, one of the filters may include a face embedding model (FEM). In some examples, a human in the loop (HITL) may be employed at one or more downstream filters, such as the filter 1345, to selectively assess and filter the synthetic and source image pairs. Source image pairs may refer to data associated with the source image 1301 (e.g., real image) and synthetically generated image (1330). In some examples, the source image pairs (e.g., SynPairs 1350) may be utilized to further train one or more ML models associated with the process 500.

In an example, the pass-through rates of the two filters may be customized. For example, the pass-through rate is determined based on one or more factors such as the identity or the visual appeal of the subject. The filter with a pass-through rate evaluates the pair consisting of the source image 1301 and the synthetic image 1330 (e.g., a media item) based on factors such as identity or visual appeal of the subject. For example, the filters may permit only the top 10%, 10% or even 1% of the synthetic image 1330 (e.g., a media item) and source image 1301 pairs to pass and ultimately be retained as training data (e.g., SynPairs 1350) for one or more other ML models.

In some implementations, the generative AI system, such as the example system architecture 1300 described with reference to FIG. 13, may interface with a private memory architecture configured to store and manage reference images and associated metadata associated with specific users or entities. Upon receiving a user's consent (e.g., via the process 500 described with reference to FIG. 5), one or more reference images (e.g., source image 1301) captured during real-time or extended capture phases may be registered into a private memory storage 1365 (e.g., private memory store) associated with that user. The private memory storage 1365 may persist over time and be accessible across sessions to support future prompt-based generation tasks without requiring the user to repeat the capture and consent process. Metadata associated with each reference image may include entity labels (e.g., “my daughter”), timestamps, verification scores, capture type (e.g., real-time or uploaded), and access permissions.

The private memory storage 1365 may be queried at inference time by the generative AI model, such as the multimodal LLM captioner 1303 or other components, to retrieve likeness data corresponding to subjects referenced in a prompt. For example, if a prompt includes “me and my dog at the beach,” the system may retrieve the user's reference image and any associated reference image stored under the entity label “my dog” to inform the generation pipeline described above (e.g., as input to model 1303 or text-to-image generation unit 1315). In some examples, multiple entities stored in memory 1350 may be retrieved concurrently and mapped to corresponding visual features, enabling multi-subject co-generation with enhanced personalization and likeness fidelity.

In some examples, the private memory storage 1365 may be permission-gated using a configurable permission-sharing model 1355. Each user may define a set of access control settings specifying which individuals (e.g., no one, mutual friends, followers, or designated users) may reference their likeness or labeled entities in generated content. These permissions may be checked in real-time when a prompt references a third party (e.g., “Me and User A at a cafe”), ensuring that the referenced user (e.g., User A) has granted access to their likeness. If permission is denied, the system may suppress or substitute the referenced likeness with a placeholder, a generic asset, or an error response.

The permission-sharing model 1355 may be administered via a user-facing settings interface 1360, allowing each user to view, update, or revoke access to their private memory. In some examples, users may grant or rescind access to individual entities (e.g., “my child”) or categories of likeness data. Audit logs may track when and by whom a reference image was used in a generation event to support transparency and accountability. Additionally, the private memory storage 1365 may support cryptographic signing or tagging of stored reference images to ensure integrity and verify the origin of the data at inference time.

Integration of the private memory storage 1365 and permission-sharing model 1355 into the generative AI system enables fine-grained, consent-based generation of personalized media. By decoupling image generation from real-time input and embedding configurable access controls, the system facilitates dynamic, multi-user collaboration while safeguarding user privacy. This framework is particularly advantageous in social, messaging, and avatar-based platforms where users routinely generate and share media featuring themselves and others.

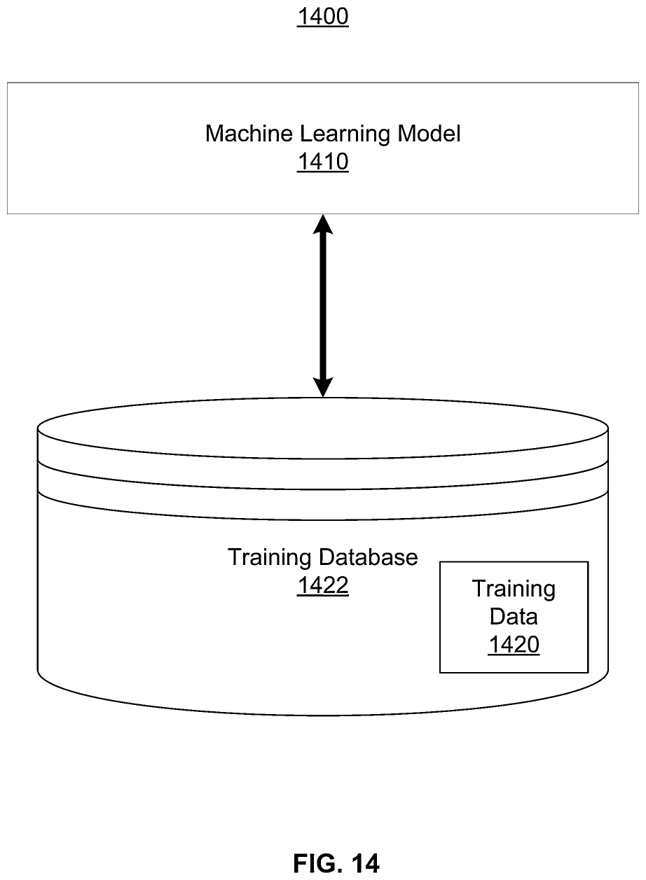

FIG. 14 illustrates a machine learning and training model, in accordance with various aspects of the present disclosure. The machine learning framework 1400 associated with the machine learning model(s) 1410 may be hosted remotely. Alternatively, the machine learning framework 1400 may reside within a server 162 shown in FIG. 1, or be processed by an electronic device (e.g., head mounted displays, smartphones, tablets, smartwatches, or any electronic device, such as communication device 105, UE 30, etc.). The machine learning model(s) 1410 may be communicatively coupled to the stored training data 1420 in a memory or database (e.g., ROM, RAM) such as training database 1122. In some examples, the machine learning model 1410 (s) may be associated with operations of any one or more of the systems/architectures depicted in subsequent figures of the application. In some other examples, the machine learning model(s) 1410 may be associated with other operations. For example, the machine learning model(s) 1410 may be associated with the process 500 described with reference to FIG. 5 and/the system architecture 1300 described with reference to FIG. 13. The machine learning model 1410 may be implemented by one or more machine learning models(s) and/or another device (e.g., a server and/or a computing system (e.g., computing system 300)). In some embodiments, the machine learning model(s) 1410 may be a student model trained by a teacher model, and the teacher model may be included in the training database 1422.

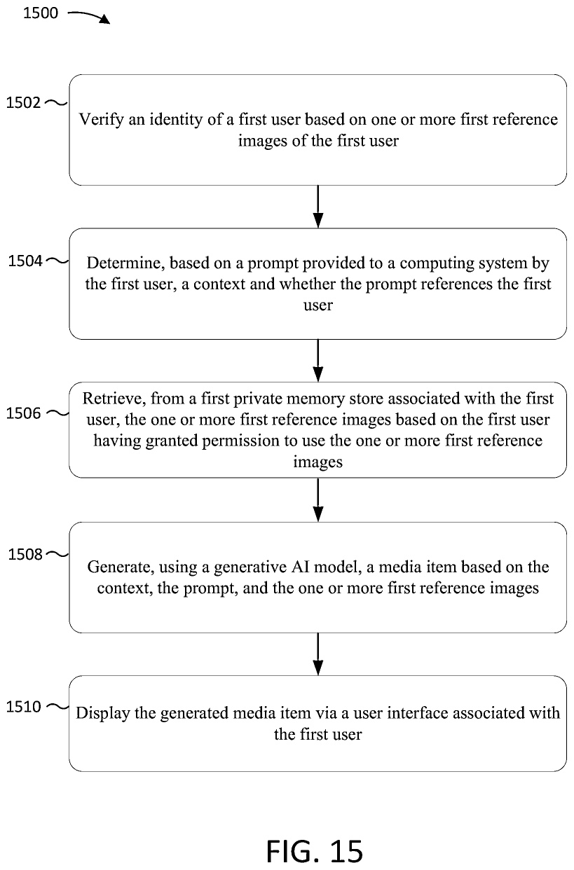

FIG. 15 is a flow diagram illustrating an example of a process 1500 performed by a generative AI platform, in accordance with some aspects of the present disclosure. The generative AI platform may be an example of a server-based or cloud-based media generation system integrated with user-specific private memory and permission-sharing components. The example process 1500 is an example of configuring a personalized media generation workflow based on user prompts, identity-linked reference data, and access control policies.

As shown in FIG. 15, the process 1500 begins at block 1502, by verifying an identity of a first user based on one or more first reference images of the first user. At block 1504, the process 1500 determines, based on a prompt provided to a computing system by the first user, a context and whether the prompt references the first user. At block 1506, the process 1500 retrieves, from a first private memory store associated with the first user, the one or more first reference images based on the first user having granted permission to use the one or more first reference images. At block 1508, the process 1500 generates, using a generative AI model, a media item based on the context, the prompt, and the one or more first reference images. At block 1510, the process 1500 displays the generated media item via a user interface associated with the first user.

In the present disclosure, the “system” may be an example of a generative AI platform, such as a platform associated with the process 500 described with reference to FIG. 5, the user interface flow 400 described with reference to FIG. 4, and/or the architecture 1300 described with reference to FIG. 13. Such a platform may operate across client applications and back-end services to manage consent, ingest and store capture data, evaluate prompts, and generate personalized media outputs in real time.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out or conducted in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

As used herein, the terms “data,” “content,” “information” and similar terms may be used interchangeably to refer to data capable of being transmitted, received and/or stored in accordance with examples of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, “artificial reality” may refer to a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. In some instances, artificial reality may be associated with applications, products, accessories, services, or some combination thereof, that may be used to, for example, create content in an artificial reality or are otherwise used in (e.g., to perform activities in) an artificial reality.

As referred to herein, “artificial reality content” may refer to content such as video, audio, haptic feedback, or some combination thereof, any of which may be presented in a single channel or in multiple channels (such as stereo video that produces a three-dimensional (3D) effect to the viewer) to a user.

As referred to herein, a Metaverse may denote an immersive virtual/augmented reality world in which augmented reality (AR) devices may be utilized in a network (e.g., a Metaverse network) in which there may, but need not, be one or more social connections among users in the network. The Metaverse network may be associated with three-dimensional (3D) virtual worlds, online games (e.g., video games), one or more content items such as, for example, non-fungible tokens (NFTs) and in which the content items may, for example, be purchased with digital currencies (e.g., cryptocurrencies) and other suitable currencies.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
verifying an identity of a first user based on one or more first reference images of the first user;
determining, based on a prompt provided to a computing system by the first user, a context and whether the prompt references the first user;
retrieving, from a first private memory store associated with the first user, the one or more first reference images based on the first user having granted permission to use the one or more first reference images;
generating, using a generative AI model, a media item based on the context, the prompt, and the one or more first reference images; and
displaying the generated media item via a user interface associated with the first user.

2. The method of claim 1, further comprising assigning a label to a reference image of the one or more first reference images to identify an entity other than the first user, wherein the label is referenced in the prompt to retrieve the first reference image from the first private memory store.

3. The method of claim 1, wherein verifying the identity of the first user comprises prompting the first user to perform one or more physical actions or facial expressions during image capture to support liveness detection.

4. The method of claim 1, further comprising receiving user-defined permission settings specifying a second user that is authorized to use the one or more first reference images to generate content at a device associated with the second user.

5. The method of claim 1, wherein a reference image of the one or more first reference images is provided from a camera roll or social media platform.

6. The method of claim 1, wherein:
the prompt references a second user; and
the method further comprises determining whether the second user granted permission to the first user to use one or more second reference images of the second user to generate the media item.

7. The method of claim 6, further comprising accessing a second private memory storage associated with the second user to use the one or more second reference images to generate the media item.

8. A system, comprising:
one or more processors; and
at least one memory communicatively coupled to the one or more processors and comprising computer-readable instructions that upon execution by the one or more processors cause the one or more processors to perform operations comprising:
verifying an identity of a first user based on one or more first reference images of the first user;
determining, based on a prompt provided to a computing system by the first user, a context and whether the prompt references the first user;
retrieving, from a first private memory store associated with the first user, the one or more first reference images based on the first user having granted permission to use the one or more first reference images;
generating, using a generative AI model, a media item based on the context, the prompt, and the one or more first reference images; and
displaying the generated media item via a user interface associated with the first user.

9. The system of claim 8, wherein:
the computer-readable instructions further cause the one or more processors to assign a label to a reference image of the one or more first reference images to identify an entity other than the first user; and
the label is referenced in the prompt to retrieve the first reference image from the first private memory store.

10. The system of claim 8, wherein verifying the identity of the first user comprises prompting the first user to perform one or more physical actions or facial expressions during image capture to support liveness detection.

11. The system of claim 8, wherein the computer-readable instructions further cause the one or more processors to receive user-defined permission settings specifying a second user that is authorized to use the one or more first reference images to generate content at a device associated with the second user.

12. The system of claim 8, wherein a reference image of the one or more first reference images is provided from a camera roll or social media platform.

13. The system of claim 8, wherein:
the prompt references a second user; and
the computer-readable instructions further cause the one or more processors to determine whether the second user granted permission to the first user to use one or more second reference images of the second user to generate the media item.

14. The system of claim 13, wherein the computer-readable instructions further cause the one or more processors to access a second private memory storage associated with the second user to use the one or more second reference images to generate the media item.

15. A non-transitory computer-readable medium comprising computer-executable instructions, which when executed cause:
verifying an identity of a first user based on one or more first reference images of the first user;
determining, based on a prompt provided to a computing system by the first user, a context and whether the prompt references the first user;
retrieving, from a first private memory store associated with the first user, the one or more first reference images based on the first user having granted permission to use the one or more first reference images;
generating, using a generative AI model, a media item based on the context, the prompt, and the one or more first reference images; and
displaying the generated media item via a user interface associated with the first user.

16. The non-transitory computer-readable medium of claim 15, wherein execution of the computer-executable instructions further causes assigning a label to a reference image of the one or more first reference images to identify an entity other than the first user, wherein the label is referenced in the prompt to retrieve the first reference image from the first private memory store.

17. The non-transitory computer-readable medium of claim 15, wherein verifying the identity of the first user comprises prompting the first user to perform one or more physical actions or facial expressions during image capture to support liveness detection.

18. The non-transitory computer-readable medium of claim 15, wherein execution of the computer-executable instructions further causes receiving user-defined permission settings specifying a second user that is authorized to use the one or more first reference images to generate content at a device associated with the second user.

19. The non-transitory computer-readable medium of claim 15, wherein a reference image of the one or more first reference images is provided from a camera roll or social media platform.

20. The non-transitory computer-readable medium of claim 15, wherein:
the prompt references a second user; and
execution of the computer-executable instructions further causes determining whether the second user granted permission to the first user to use one or more second reference images of the second user to generate the media item.
